(19) United States
(12) Patent Application Publication
(10) Pub. No.: US 2025/0343006 A1
(43) Pub. Date: Nov. 6, 2025

(54) MULTILAYER CERAMIC ELECTRONIC COMPONENT AND METHOD OF MANUFACTURING THE SAME

(71) Applicant: TAIYO YUDEN CO., LTD., Tokyo (JP)

(72) Inventor: Yoshinari TAKE, Tokyo (JP)

(73) Assignee: TAIYO YUDEN CO., LTD., Tokyo (JP)

(21) Appl. No.: 19/267,092

(22) Filed: Jul. 11, 2025

Related U.S. Application Data
(63) Continuation of application No. PCT/JP2023/044652, filed on Dec. 13, 2023.

(30) Foreign Application Priority Data
Feb. 3, 2023 (JP) 2023-015462

(51) Int. Cl. H01G 4/30; H01G 4/012; H01G 4/232

(52) U.S. Cl. CPC H01G 4/30; H01G 4/012; H01G 4/2325

(57) ABSTRACT

A multilayer ceramic electronic component includes a ceramic element having dielectric layers and internal electrodes that are alternately laminated, main surfaces along a first axis direction, side surfaces along a second axis direction, and end surfaces along a third axis direction, step portions formed at both ends of at least one surface of the main surfaces and the side surfaces along the third axis direction, and external electrodes each including a base layer provided on each of both ends of the ceramic element in the third axis direction to cover the step portions, and a plating layer covering the base layer. A center-side end of the base layer located near a center of the ceramic element is located closer to the center of the ceramic element than a center-side end of each of the step portions located near the center of the ceramic element.

### CROSS-REFERENCE TO RELATED APPLICATION

This continuation application is based upon and claims the benefit of priority of International Patent Application No. PCT/JP2023/044652, filed on Dec. 13, 2023, which claims the benefit of priority of Japanese Patent Application No. 2023-015462, filed on Feb. 3, 2023, the entire contents of which are incorporated herein by reference.

### FIELD

A certain aspect of the present invention relates to a multilayer ceramic electronic component and a method of manufacturing the same.

### BACKGROUND

In recent years, a wide variety of multilayer ceramic electronic components have been used in high-frequency communication systems typified by portable terminals such as mobile phones and smartphones. These multilayer ceramic electronic components include external electrodes that are electrically connected to lands or the like when the multilayer ceramic electronic components are mounted on a substrate. Each of the external electrode is connected to internal electrodes provided in the ceramic element. The thickness of such an external electrode is preferably as small as possible from the viewpoint of increasing the number of layers (increasing the capacitance) of the multilayer ceramic electronic component and reducing the size and thickness of the multilayer ceramic electronic component. International Publication Pamphlet No. WO2007/148484 (hereinafter referred as Patent Document 1) discloses a method for manufacturing a multilayer ceramic electronic component, including a step of providing a metal foil having a thickness of 0.1 to 1.0 μm on both ends of a multilayer body before firing in which dielectrics and internal electrodes are laminated, and firing the multilayer body. In the multilayer ceramic electronic component manufactured by the manufacturing method disclosed in Patent Document 1, the metal foil functions as a base layer of the external electrode and can be used as a seed layer for plating. This makes it possible to reduce the thickness of the external electrode as compared with the case where the base layer of the external electrode is formed by paste application, and thus contributes to the increase in the number of layers and the reduction in the size and thickness of the multilayer ceramic electronic component.

### SUMMARY OF THE INVENTION

(1) According to an aspect of the present disclosure, there is provided a multilayer ceramic electronic component including: a ceramic element having dielectric layers and internal electrodes that are alternately laminated, a pair of main surfaces facing each other along a first axis direction, a pair of side surfaces facing each other in a second axis direction orthogonal to the first axis direction, and a pair of end surfaces facing each other in a third axis direction orthogonal to the first axis direction and the second axis direction; step portions formed at both ends of at least one surface of the pair of main surfaces and the pair of side surfaces along the third axis direction; and external electrodes each including a base layer provided on each of both ends of the ceramic element in the third axis direction to cover the step portions, and a plating layer covering the base layer; wherein a center-side end of the base layer located near a center of the ceramic element is located closer to the center of the ceramic element than a center-side end of each of the step portions located near the center of the ceramic element.
(2) In the multilayer ceramic electronic component according to the above (1), the base layer may be a conductive thin film having a thickness of 0.1 μm or more and 1.5 μm or less.
(3) In the multilayer ceramic electronic component according to the above (1), the step portions may be provided at both ends of each of the pair of main surfaces along the third axis direction, and each of the external electrodes may include the base layer covering each of the step portions and the plating layer covering the base layer.
(4) In the multilayer ceramic electronic component according to the above (1), the internal electrodes may be alternately led out to the pair of end surfaces of the ceramic element, and each of the external electrodes may be continuously formed on each of the pair of end surfaces, the pair of main surfaces adjacent to the each of the pair of end surfaces, and the pair of side surfaces adjacent to the each of the pair of end surfaces.
(5) In the multilayer ceramic electronic component according to the above (4), the step portions may be provided at both ends of each of the pair of main surfaces and the pair of side surfaces along the third axis direction, and each of the external electrodes may include the base layer covering each of the step portions and the plating layer covering the base layer.
(6) In the multilayer ceramic electronic component according to the above (1), the internal electrode may include a first internal electrode and a second internal electrode laminated on the first internal electrode with the dielectric layer interposed therebetween, and the external electrode may include a first external electrode connected to the first internal electrode, and a second external electrode provided separately from the first external electrode and connected to the second internal electrode.
(7) In the multilayer ceramic electronic component according to the above (6), the ceramic element may include cover layers covering the dielectric layers, the first internal electrodes and the second internal electrodes from the first axis direction, and side margins covering the dielectric layers, the first internal electrodes and the second internal electrodes from the second axis direction, and the step portions may be formed in the cover layers and the side margins.
(8) In the multilayer ceramic electronic component according to the above (1), each of the step portion may include a protrusion.
(9) In the multilayer ceramic electronic component according to the above (1), the internal electrode may include first internal electrodes and second internal electrodes alternately arranged along the first axis direction, the first internal electrodes may be connected to each other through a first via extending along the first axis direction, the second internal electrodes may be connected to each other through a second via extending along the first axis direction, the step portions may be provided at both ends of one surface of the pair of main surfaces along the third axis direction, the first via may penetrate one of the step portions and may be connected to one of the external electrodes, and the second via may penetrate another of the step portions and may be connected to another of the external electrodes.
(10) According to another aspect of the present disclosure, there is provided a method of manufacturing a multilayer ceramic electronic component, including: forming a multilayer ceramic body having dielectric layers and internal electrodes that are alternately laminated, a pair of main surfaces facing each other along a first axis direction, a pair of side surfaces facing each other in a second axis direction orthogonal to the first axis direction, and a pair of end surfaces facing each other in a third axis direction orthogonal to the first axis direction and the second axis direction, the internal electrodes being alternately led out to the pair of end surfaces of the multilayer ceramic body; forming step portions protruding from at least one surface of the pair of main surfaces in the first axis direction at both ends of the at least one surface of the pair of main surfaces along the third axis direction to obtain a ceramic element; forming a base layer so that a center-side end of the base layer located near a center of the ceramic element is located closer to the center of the ceramic element than a center-side end of each of the step portions located near the center of the ceramic element; and forming a plating layer to cover the base layer.

### BRIEF DESCRIPTION OF THE DRAWINGS

FIG. 1 is a perspective view of a multilayer ceramic capacitor according to a first embodiment.

FIG. 2 is a cross-sectional view taken along a line An-An in FIG. 1.

FIG. 3 is a cross-sectional view taken along a line An-An in FIG. 1, and illustrates a cross section taken along the line An-An set at a position different from that in FIG. 2.

FIG. 4 is an enlarged view of an X1 portion in FIG. 2.

FIG. 5 is a cross-sectional view taken along a line B1-B1 in FIG. 1.

FIG. 6 is a cross-sectional view taken along a line C1-C1 in FIG. 1.

FIG. 7 is a flowchart illustrating an example of a method for manufacturing the multilayer ceramic capacitor of the first embodiment.

FIGS. 8A to 8C are cross-sectional views illustrating some steps included in the method of manufacturing the multilayer ceramic capacitor according to the first embodiment.

FIGS. 9A to 9C are cross-sectional views illustrating some steps included in the method of manufacturing the multilayer ceramic capacitor according to the first embodiment.

FIGS. 10A and 10B are cross-sectional views illustrating some steps included in the method of manufacturing the multilayer ceramic capacitor according to the first embodiment.

FIGS. 11A and 11B are cross-sectional views illustrating some steps included in the method of manufacturing the multilayer ceramic capacitor according to the first embodiment.

FIG. 12 is a cross-sectional view of a multilayer ceramic capacitor according to a second embodiment.

FIG. 13 is a cross-sectional view of a multilayer ceramic capacitor according to a third embodiment.

FIG. 14 is a cross-sectional view of the multilayer ceramic capacitor of the third embodiment, and illustrates a cross section at a position shifted in a Y-axis direction with respect to the position of the cross section illustrated in FIG. 13.

### DETAILED DESCRIPTION

In the ends of the external electrode located on the upper and lower surfaces of the multilayer ceramic electronic component, internal stress of the multilayer ceramic electronic component or stress generated by external force applied thereto is locally concentrated, which may lead to peeling between the ceramic element and the external electrode. For example, when the peeling progresses from the ends of the external electrode, moisture or the like enters the inside of the multilayer ceramic electronic component, which causes a decrease in reliability thereof. In this regard, the multilayer ceramic electronic component manufactured by the manufacturing method disclosed in Patent Document 1 has room for improvement.

An object of the present disclosure is to suppress peeling between the ceramic element and the external electrode in the multilayer ceramic electronic component.

Hereinafter, a circuit board according to an embodiment of the present invention will be described with reference to the accompanying drawings. In the drawings, the dimensions, ratios, and the like of the respective parts may not be illustrated so as to completely match the actual ones. For convenience of drawing, details may be omitted or components themselves may be omitted depending on the drawings. In the drawings, an X-axis, a Y-axis, and a Z-axis orthogonal to each other are illustrated as appropriate. In the following description, a Z-axis direction corresponds to a first axis direction, and a Y-axis direction corresponds to a second axis direction. An X-axis direction corresponds to a third axis direction.

### First Embodiment

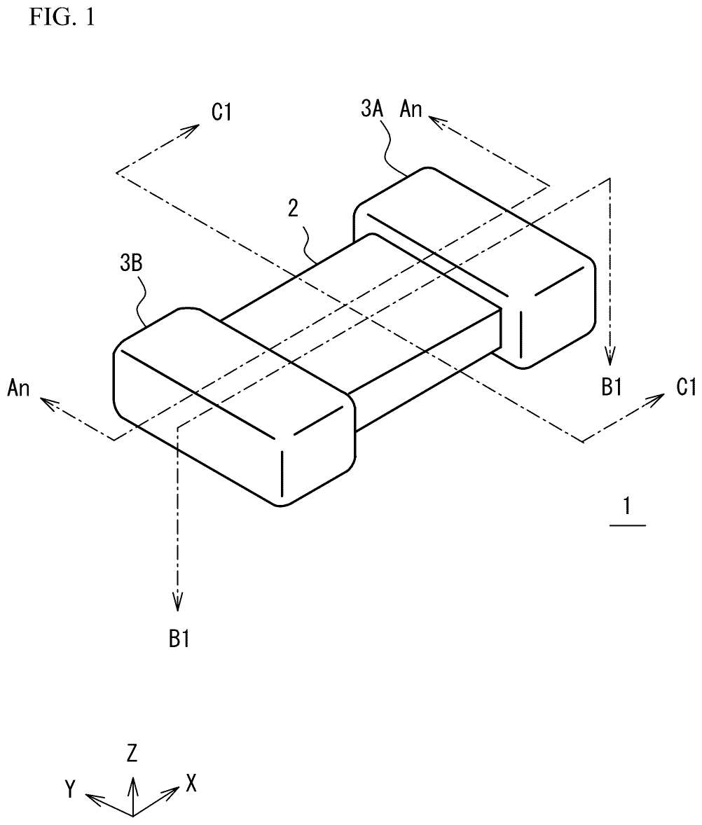

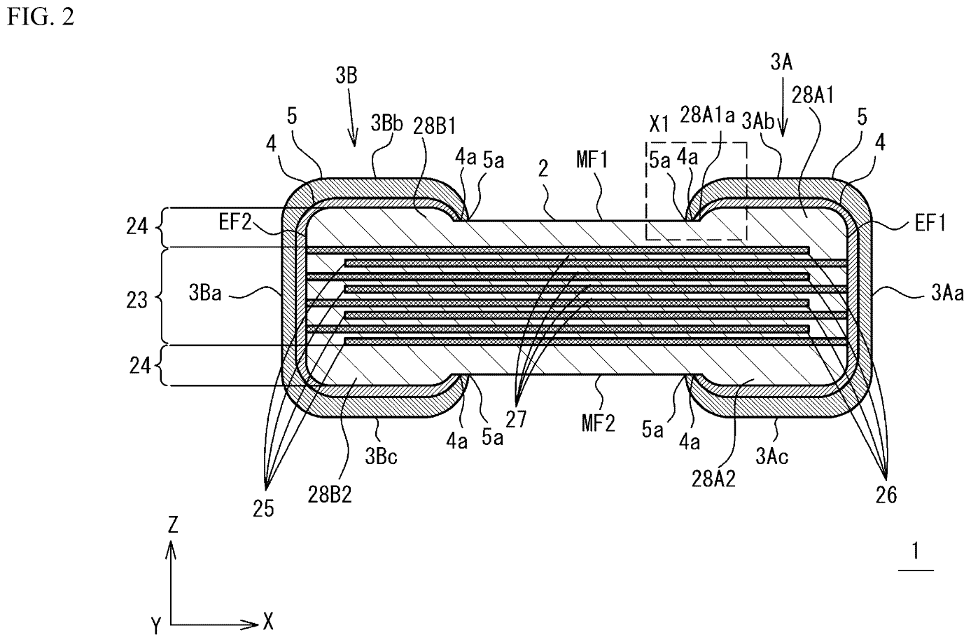

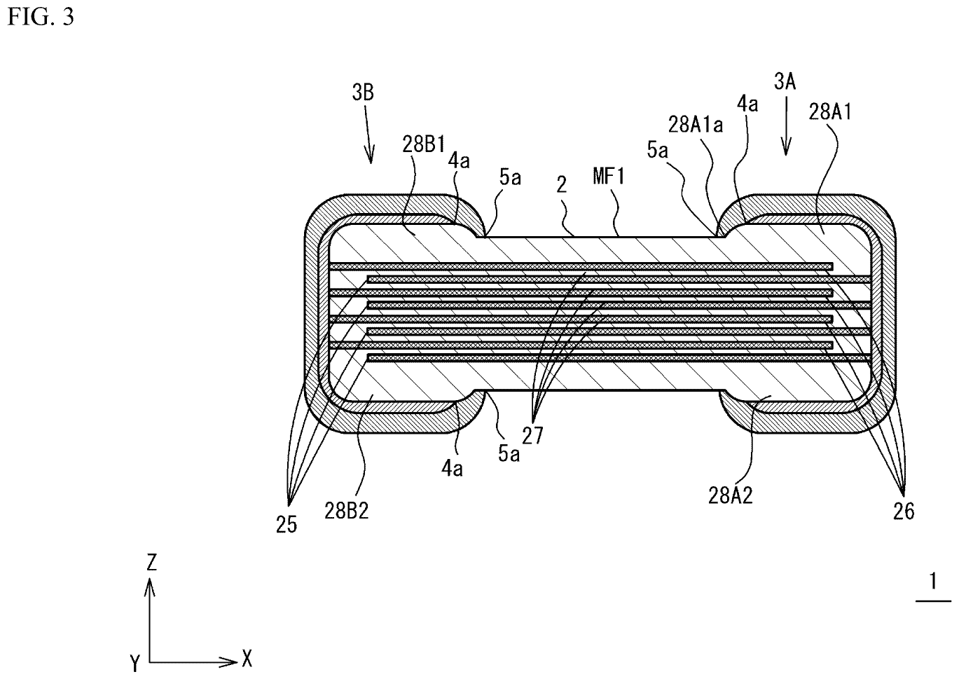

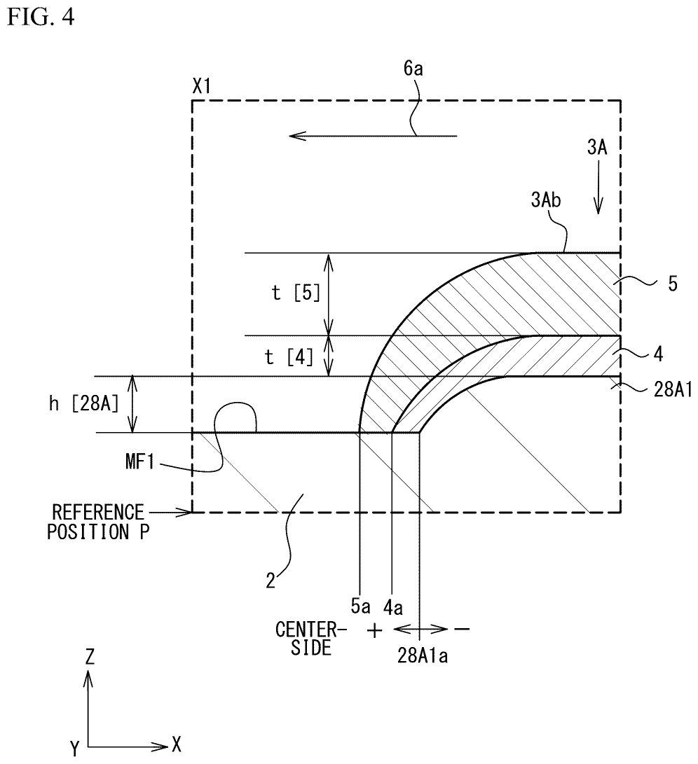

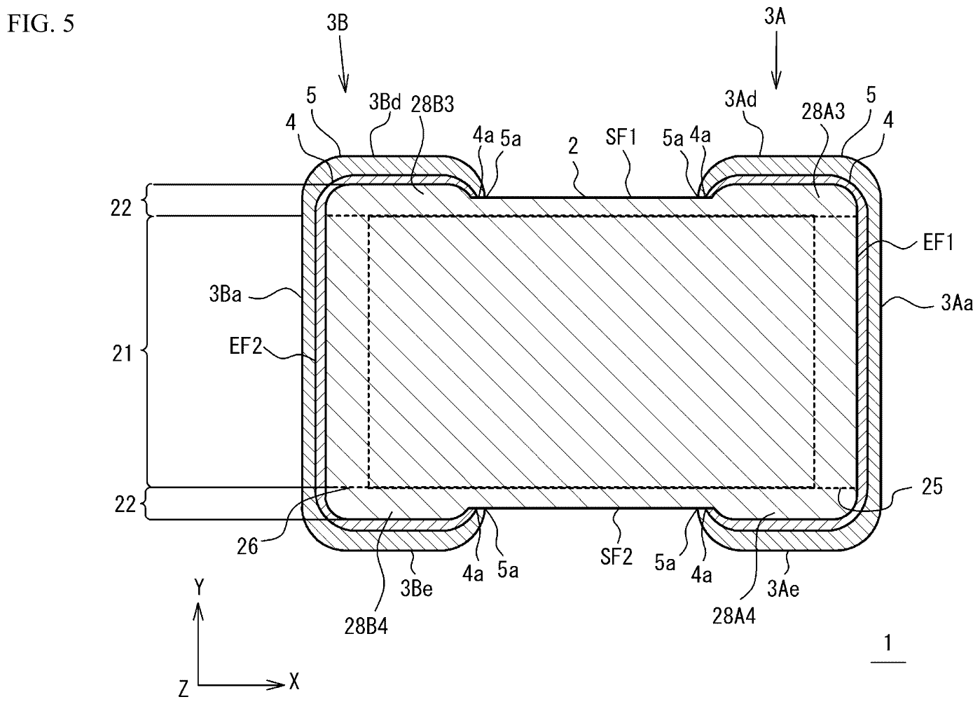

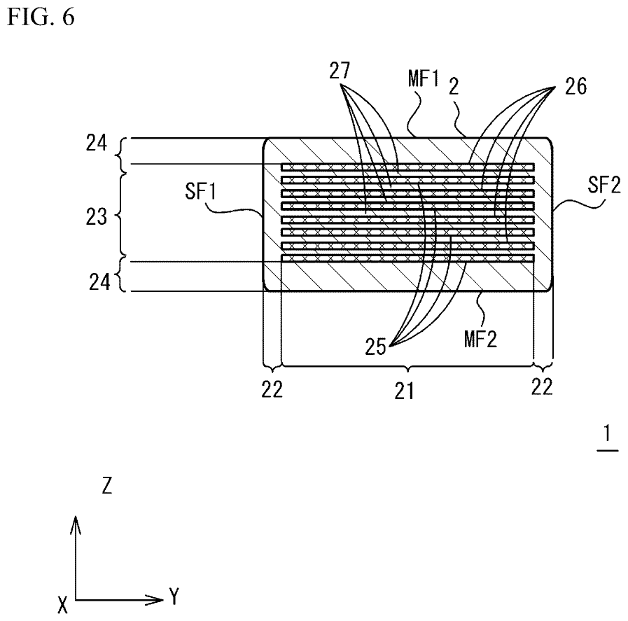

First, a multilayer ceramic capacitor (MLCC) 1 according to a first embodiment will be described with reference to FIGS. 1 to 6. FIG. 1 is a perspective view of a multilayer ceramic capacitor 1 according to a first embodiment. FIG. 2 is a cross-sectional view taken along a line An-An in FIG. 1. FIG. 3 is a cross-sectional view taken along a line An-An in FIG. 1, and illustrates a cross section taken along the line An-An set at a position different from that in FIG. 2. FIG. 4 is an enlarged view of an X1 portion in FIG. 2. FIG. 5 is a cross-sectional view taken along a line B1-B1 in FIG. 1. FIG. 6 is a cross-sectional view taken along a line C1-C1 in FIG. 1. Note that “n” in the notation of the line An-An in FIG. 1 indicates that the position of the cross section is shifted along the Y-axis direction. Therefore, FIGS. 2 and 3 illustrate the states of the cross sections whose positions are shifted along the Y-axis direction. In the multilayer ceramic capacitor 1, the X-axis direction is the length direction, the Y-axis direction is the width direction, and the Z-axis direction is the height direction.

The multilayer ceramic capacitor 1 includes a ceramic element 2, a first external electrode 3A provided at one end of the multilayer ceramic capacitor 1 in the length direction, and a second external electrode 3B provided at the other end of the multilayer ceramic capacitor 1.

The ceramic element 2 is formed as a hexahedron having first and second main surfaces MF1 and MF2 orthogonal to the Z-axis, first and second end surfaces EF1 and EF2 orthogonal to the X-axis, and first and second side surfaces SF1 and SF2 orthogonal to the Y-axis. The “hexahedron” may be substantially a hexahedron, and for example, ridges connecting the surfaces of the ceramic element 2 may be rounded.

The main surface MF1 and MF2, the end surface EF1 and EF2, and the side surface SF1 and SF2 of the ceramic element 2 are all formed as flat surfaces. The flat surface according to the present embodiment may not be strictly a plane as long as it is a surface recognized as flat when viewed as a whole, and includes, for example, a surface having a minute uneven shape of the surface, a gently curved shape existing in a predetermined range, or the like.

The ceramic element 2 includes a multilayer portion 21 and a pair of side margins 22. The multilayer portion 21 includes a capacitance forming portion 23 and a pair of cover layers 24. The capacitance forming portion 23 includes a plurality of first internal electrodes 25 and a plurality of second internal electrodes 26 that are alternately laminated with a plurality of dielectric layers 27 along the Z-axis direction. In the present embodiment, the first internal electrode 25, the second internal electrode 26, and the dielectric layer 27 are each configured in a sheet shape extending along the X-Y plane. The multilayer number of first internal electrodes 25 and the multilayer number of second internal electrodes 26 in each drawing does not represent the actual number of the multilayers.

The first internal electrode 25 and the second internal electrode 26 are alternately arranged along the Z-axis direction (height direction) so as to face each other in the Z-axis direction. The first internal electrode 25 and the second internal electrode 26 face each other in the Z-axis direction in an opposing region at the center in the X-axis direction and the Y-axis direction. The first internal electrodes 25 are led out from the opposing region to the one end surface EF1 and connected to the first external electrode 3A. The second internal electrodes 26 are led out from the opposing region to the other end surface EF2 and connected to the second external electrode 3B.

The thicknesses of the first internal electrode 25 and the second internal electrode 26 along the Z-axis direction can be set in a range of 0.05 μm or more and 25 μm or less, and is, for example, 0.3 μm. The material of the first internal electrode 25 and the second internal electrode 26 can be selected from metals such as Cu (copper), Fe (iron), Zn (zinc), Al (aluminum), Sn (tin), Ni (nickel), Ti (titanium), Ag (silver), Au (gold), Pt (platinum), Pd (palladium), Ta (tantalum), and W (tungsten), and may be an alloy containing these metals.

With this configuration, in the multilayer ceramic capacitor 1, when a voltage is applied between the first external electrode 3A and the second external electrode 3B, the voltage is applied to the plurality of dielectric layers 27 between the first internal electrodes 25 and the second internal electrodes 26 in the opposing region. Thus, in the multilayer ceramic capacitor 1, electric charges corresponding to the voltage between the first external electrode 3A and the second external electrode 3B are stored.

In the multilayer portion 21, a dielectric ceramic having a high dielectric constant is used in order to increase the capacitance of each dielectric layer 27 between the first internal electrode 25 and the second internal electrode 26. Examples of the dielectric ceramics having a high dielectric constant include materials having a perovskite structure containing barium (Ba) and titanium (Ti), typified by barium titanate (BaTiO₃).

The dielectric ceramics may be a composition system such as strontium titanate (SrTiO₃), calcium titanate (CaTiO₃), magnesium titanate (MgTiO₃), calcium zirconate (CaZrO₃), calcium zirconate titanate (Ca (Zr, Ti) O₃), barium calcium zirconate titanate ((Ba, Ca) (Zr, Ti) O₃), barium zirconate (BaZrO₃), and titanium oxide (TiO₂). Here, a low melting point metal may be added to the dielectric ceramics instead of the addition of the low melting point metal to the first internal electrode 25 and the second internal electrode 26, or together with the addition of the low melting point metal to the first internal electrode 25 and the second internal electrode 26.

The pair of cover layers 24 covers the capacitance forming portion 23 from both sides in the Z-axis direction as a laminating direction. The cover layer 24 may also be referred to as a protective layer in the height direction. The cover layer 24 is formed of, for example, a multilayer body having ceramic sheets extending along the X-Y plane. The dielectric ceramics constituting the cover layer 24 preferably has the same composition as the dielectric layer 27 from the viewpoint of suppressing internal stress and the like.

The pair of side margins 22 are formed along the Z-axis direction and cover the multilayer portion 21 from the Y-axis direction. The side margin 22 may be referred to as a protective layer in the width direction. The side margin 22 is formed on a surface of the multilayer portion 21 orthogonal to the Y axis. The dielectric ceramics constituting the side margins 22 preferably has the same composition as the dielectric layers 27 from the viewpoint of reducing internal stress and the like.

The ceramic element 2 includes step portions 28A1 to 28A4 and 28B1 to 28B4.

The step portions 28A1 to 28A4 are formed near the first end surface EF1. The step portion 28A1 is formed in the first main surface MF1. The step portion 28A2 is formed in the second main surface MF2. That is, the step portions 28A1 and 28A2 are formed in the cover layer 24. The step portion 28A3 is formed in the first side surface SF1. The step portion 28A4 is formed in the second side surface SF2. That is, the step portions 28A3 and 28A4 are formed in the side margin 22.

The step portions 28B1 to 28B4 are formed near the second end surface EF2. The step portion 28B1 is formed in the first main surface MF1. The step portion 28B2 is formed in the second main surface MF2. That is, the step portions 28B1 and 28B2 are formed in the cover layer 24. The step portion 28B3 is formed in the first side surface SF1. The step portion 28B4 is formed in the second side surface SF2. That is, the step portions 28B3 and 28B4 are formed in the side margin 22.

Although the step portions of the present embodiment are provided on all of the pair of main surfaces MF1 and MF2 and the pair of side surfaces SF1 and SF2, the step portions may be provided on at least one of these surfaces.

The multilayer ceramic capacitor includes the first external electrode 3A provided at one end of the multilayer ceramic capacitor 1 in the length direction (X-axis direction) and the second external electrode 3B provided at the other end of the multilayer ceramic capacitor 1.

The first external electrode 3A includes a first surface portion 3Aa covering the end surface EF1 of the ceramic element 2. The first external electrode 3A includes a second surface portion 3Ab extending from the first surface portion 3Aa to the first main surface MF1, and a third surface portion 3Ac extending from the first surface portion 3Aa to the second main surface MF2 (referring to FIG. 2). Further, the first external electrode 3A includes a fourth surface portion 3Ad extending from the first surface portion 3Aa to the first side surface SF1, and a fifth surface portion 3Ae extending from the first surface portion 3Aa to the second side surface SF2 (referring to FIG. 5).

The second surface portion 3Ab is provided so as to cover the step portion 28A1. The third surface portion 3Ac is provided so as to cover the step portion 28A2. The fourth surface portion 3Ad is provided so as to cover the step portion 28A3. The fifth surface portion 3Ae is provided so as to cover the step portion 28A4.

The second external electrode 3B includes a first surface portion 3Ba covering the end surface EF2 of the ceramic element 2. The second external electrode 3B includes a second surface portion 3Bb extending from the first surface portion 3Ba to the first main surface MF1, and a third surface portions 3Bc extending from the first surface portion 3Ba to the second main surface MF2 (referring to FIG. 2). Further, the second external electrode 3B includes a fourth surface portion 3Bd extending from the first surface portion 3Ba to the first side surface SF1, and a fifth surface portion 3Be extending from the first surface portion 3Ba to the second side surface SF2 (referring to FIG. 5).

The second surface portion 3Bb is provided so as to cover the step portion 28B1. The third surface portion 3Bc is provided so as to cover the step portion 28B2. The fourth surface portion 3Bd is provided so as to cover the step portion 28B3. The fifth surface portion 3Be is provided so as to cover the step portion 28B4.

In the first external electrode 3A and the second external electrode 3B, both the cross section parallel to the X-Z plane and the cross section parallel to the X-Y plane have a U shape. The shapes of the first external electrode 3A and the second external electrode 3B are not limited to the examples illustrated in the drawings.

Each of the first external electrode 3A and the second external electrode 3B includes a base layer 4 and a plating layer 5 laminated on the base layer 4.

The base layers 4 are formed on the pair of end surfaces EF1 and EF2 of the ceramic element 2 so as to face each other in a state of being separated from each other in the X-axis direction (length direction), and are connected to the first internal electrode 25 and the second internal electrode 26, respectively. At this time, the base layer 4 is formed continuously on the end surfaces EF1 and EF2 of the ceramic element 2 and four peripheral surfaces, i.e., the main surfaces MF1 and MF2 and the side surfaces SF1 and SF2 adjacent to the end surfaces EF1 and EF2, and is provided on the step portions provided in the four peripheral surfaces.

The base layer 4 is formed as a conductive thin film. The base layer 4 formed as a conductive thin film may be mainly composed of a metal or an alloy containing at least one of Cu, Ti, Cr, Al, Mg, Fe, Zn, Mo, Pd, Ag, Sn, Ta, W, Pt, Au, and the like, in addition to Ni, but any other conductive metal may be used. The base layer 4 may contain a co-fired material. The co-fired material is mixed in the base layer 4 in an island shape, and thus, a difference in thermal expansion coefficient between the ceramic element 2 and the base layer 4 is reduced, and stress applied to the base layer 4 can be relaxed. The co-fired material is, for example, a ceramic component that is a main component of the dielectric layer 27. The base layer 4 may contain a glass component. The glass component can densify the base layer 4 by being mixed in the base layer 4. The glass component is, for example, an oxide of Ba (barium), Sr (strontium), Ca (calcium), Zn, Al, Si (silicon), B (boron), or the like.

The plating layer 5 is continuously formed on each of the first external electrode 3A and the second external electrode 3B so as to cover the base layer 4. The plating layer 5 is electrically connected to the first internal electrode 25 and the second internal electrode 26 via the base layer 4.

The material of the plating layer 5 may be, for example, a metal or an alloy including at least one selected from Cu, Fe, Zn, Al, Ni, Pt, Pd, Ag, Au, and Sn. The plating layer 5 may be a plating layer of a single metal component or may be a plurality of plating layers of different metal components. The plating layer 5 may have a structure including a plurality of layers, for example, a Cu plating layer formed on the base layer 4, a Ni plating layer formed on the Cu plating layer, and a Sn plating layer formed on the Ni plating layer.

Here, the relationship between the step portions, and the base layer 4 and the plating layer 5 will be described in more detail.

FIGS. 2 and 3 both illustrate the internal state of the multilayer ceramic capacitor 1 when the multilayer ceramic capacitor 1 is cut along the X-axis direction, but FIGS. 2 and 3 illustrate the state of the multilayer ceramic capacitor 1 when the multilayer ceramic capacitor 1 is cut at positions shifted in the Y-axis direction. FIGS. 2 and 3 both illustrate cross sections parallel to the X-Z plane. FIG. 4 illustrates an enlarged view of an X1 portion in FIG. 2. In FIG. 4, an arrowed line 6a indicates the center direction of the ceramic element 2. Referring to FIG. 4, a center-side end 4a of the base layer 4 located near the center of the ceramic element 2 is located closer to the center of the ceramic element 2 than a center-side end 28A1a of the step portion 28A1 located near the center of the ceramic element 2.

That is, as illustrated in FIG. 4, the center-side end 4a of the base layer 4 is located on the + (plus) side of the center-side end 28A1a of the step portion 28A1. A center-side end 5a of the plating layer 5 is located closer to the center of the ceramic element 2 (on the plus side in FIG. 4) than the center-side end 4a of the base layer 4.

In contrast, referring to FIG. 3, the center-side end 4a of the base layer 4 is located farther from the center side of the ceramic element 2 than the center-side end 28A1a of the step portion 28A1.

As described above, the multilayer ceramic capacitor 1 of the present embodiment includes a portion having the cross section as illustrated in FIG. 2 and a portion having the cross section as illustrated in FIG. 3. By adopting an aspect in which the center-side end 4a of the base layer 4 and the center-side end 28A1a of the step portion 28A1 have such a relationship, the adhesion between the first external electrode 3A and the ceramic element 2 is improved, and the separation between the ceramic element 2 and the first external electrode 3A can be suppressed. The same effect can be also obtained in the ceramic element 2 and the second external electrode 3B.

In the multilayer ceramic capacitor 1, it is sufficient that the relationship between the center-side end 4a of the base layer 4 and the center-side end 28A1a of the step portion 28A1 as illustrated in FIG. 2 is realized in a cross section at any position in the Y-axis direction. In addition, the cross section in the state illustrated in FIG. 3 is not provided, and the center-side end 4a of the base layer 4 may be located closer to the center of the multilayer ceramic capacitor 1 than the center-side end 28A1a of the step portion 28A1 as illustrated in FIG. 2 in the entire region in the Y-axis direction.

In the above description, the relationship between the step portion 28A1 and the base layer 4 has been described, but the same applies to the other step portions 28A2 to 28A4 and the step portions 28B1 to 28B4, and thus, the detailed description thereof will be omitted here. In addition, the height of the step portion 28A1 will be described later, but the same description will be given of the heights of the other step portions 28A2 to 28A4 and the other step portions 28B1 to 28B4, and thus the description thereof will be omitted.

The size of the multilayer ceramic capacitor 1 is not particularly limited, but for example, as designed values, any one of the sizes of 0. 25 mm long, 0. 125 mm wide, and 0. 125 mm high (0201 size), 0. 4 mm long, 0. 2 mm wide, and 0. 2 mm high (0402 size), 0.6 mm long, 0.3 mm wide, and 0. 3 mm high (0603 size), 1. 0 mm wide, 0. 5 mm wide, and 0. 5 mm high (1005 size), 3. 2 mm wide, 1. 6 mm wide, and 1. 6 mm high (3216 size), 4. 5 mm wide, 3. 2 mm wide, and 2. 5 mm high (4532 size), and 5. 7 mm wide, 5. 0 mm wide, and 2. 3 mm high (5750 size) can be selected. Alternatively, the size of the multilayer ceramic capacitor 1 may be 1. 0 mm long, 0. 5 mm wide, and 0. 1 mm height.

The thickness t [5] of the plating layer 5 at the first external electrode 3A and the second external electrode 3B (see FIG. 4) may be, for example, about 1 μm or more and about 15 μm or less. Preferably, the thickness can be 5 μm or more and 10 μm or less. The thickness t [4] of the base layer 4 (see FIG. 4) is preferably 0.1 μm or more and 1.5 μm or less from the viewpoint of conductivity and reduction in thickness. Preferably, the thickness can be set to 0.5 μm or more and 1.0 μm or less. For example, the thickness t [5] of the plating layer 5 may be 10 μm, and the thickness t [4] of the base layer 4 may be 1 μm.

As illustrated as the height h [28A] of the step portion 28A1 in FIG. 4, the height h [28A] of each step portion (the heights of the step portions other than the step portion A1 are not illustrated) is preferably about 0.2 μm or more and about 2.0 μm or less, for example, in order to ensure the adhesion to the first external electrode 3A and the second external electrode 3B and the strength of the ceramic element 2. More preferably, the height h [28A] of each step portion can be set to 0.4 μm or more and 1.0 μm or less. Here, the measurement of the height h [28A] of the step portion will be described. For example, it is assumed that the enlarged view of the X1 portion illustrated in FIG. 4 is an SEM photograph taken at a predetermined angle of view. Then, a distance from the lower edge of the SEM photograph (reference position P in FIG. 4) to the step portion 28A1 and a distance from the reference position P to the first main surface MF1 are calculated, and a difference between the above distances is defined as the height h [28A] of the step portion. The distance from the reference position P to the step portion 28A1 can be measured at any 10 points, for example, and the average of the measured values can be set as the above distance. Similarly, the distance from the reference position P to the first main surface MF1 can be measured at any 10 points and the average of the measured values can be set as the above distance. The reference position P can be set as appropriate.

As illustrated in FIGS. 2 and 3, the center-side end 4a of the base layer 4 may be located closer to the center of the multilayer ceramic capacitor 1 than the center-side end of the step portion, or may be located in a direction away from the center. As illustrated in FIG. 4, the center-side end 4a of the base layer 4 is set so as to fall within a range of +10 μm with reference to the center-side end of the step portion. More preferably, the width is set within a range of +3 μm with reference to the center-side end of the step portion. Further, the position of the center-side end 4a of the base layer 4 may be within a range of the thickness of the base layer 4 or less with reference to the center-side end of the step portion.

The step portion 28A1 formed in the main surface MF1 and the step portion 28A2 formed in the main surface MF2 are provided over the entire region in the Y-axis direction, but may be provided over a part of the entire region in the Y-axis direction. Further, the step portion 28A3 formed on the side surface SF1 and the step portion 28A4 formed on the side surface SF2 are respectively provided over the entire region in the Z-axis direction, but may be provided over a part of the entire region in the Z-axis direction.

### [Production Method]

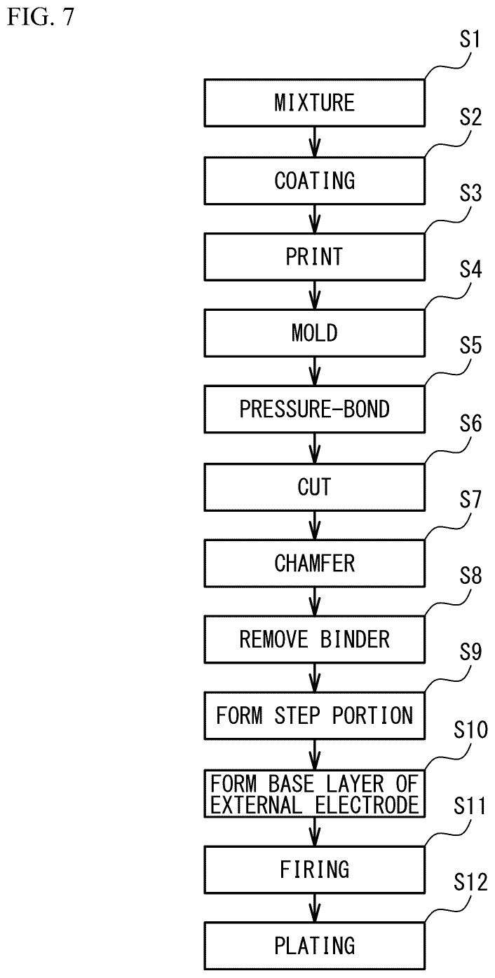

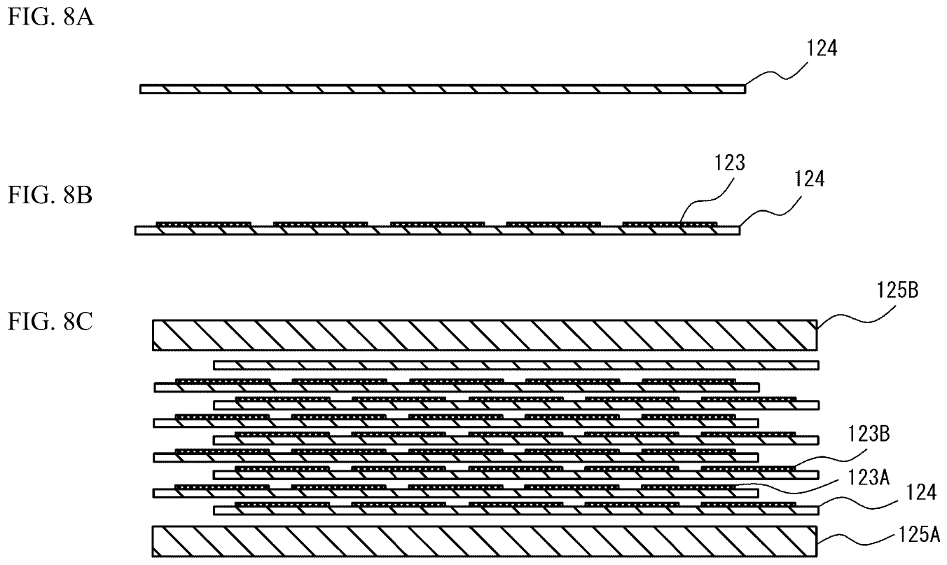

Next, an example of a method for manufacturing the multilayer ceramic capacitor 1 will be described with reference to FIGS. 7 to 11B. FIG. 7 is a flowchart illustrating an example of a method for manufacturing the multilayer ceramic capacitor 1 according to the first embodiment. FIGS. 8A to 11B are cross-sectional views illustrating some steps included in the method of manufacturing the multilayer ceramic capacitor according to the first embodiment.

In step S1 of FIG. 7, an organic binder and an organic solvent which serve as a dispersing agent and a forming aid are added to the dielectric material powder, and the mixture is pulverized and mixed to produce a slurry. The dielectric material powder includes, for example, ceramic powder. The dielectric material powder may contain an additive. The additive is, for example, an oxide of Mg, Mn, V, Cr, Y, Sm, Eu, Gd, Tb, Dy, Ho, Er, Tm, Yb, Co, Ni, Li, B, Na, K, or Si, or glass. The organic binder is, for example, a polyvinyl butyral resin or a polyvinyl acetal resin. The organic solvent is, for example ethanol or toluene.

Next, as illustrated in step S2 of FIG. 7 and FIG. 8A, a slurry containing ceramic powder is applied in a sheet shape on a career film and dried to produce a green sheet 124. The carrier film is, for example, a PET (polyethylene terephthalate) film. The slurry may be applied by a doctor blade method, a die coater method, a gravure coater method, or the like.

Next, as illustrated in step S3 of FIG. 7 and FIG. 8B, the conductive paste for internal electrode is applied as predetermined patterns to green sheets 124 of the layers forming the first internal electrode 25 and the second internal electrode 26 among the plurality of green sheets, thereby forming internal electrode patterns 123. In this case, the plurality of internal electrode patterns 123 separated in a longitudinal direction of the green sheet 124 may be formed on one green sheet 124. The conductive paste for internal electrode contains a powder of a metal used as a material of the first internal electrode 25 and the second internal electrode 26. For example, when the metal used as the material of the first internal electrode 25 and the second internal electrode 26 is Ni, the conductive paste for internal electrode contains Ni powder. The conductive paste for internal electrode includes a binder, a solvent, and an auxiliary agent as necessary. The conductive paste for internal electrode may include a ceramic material that is a main component of the dielectric layer 27, as a co-fired material. The conductive paste for internal electrode may be applied by a screen printing method, an inkjet printing method, a gravure printing method, or the like.

Next, as illustrated in step S4 of FIG. 7 and FIG. 8C, a plurality of green sheets 124 on which the internal electrode patterns 123 are formed and a plurality of green sheets 125A and 125B for cover layers on which the internal electrode patterns 123 are not formed are laminated in a predetermined order to produce a multilayer block. The green sheets 125A and 125B for the cover layers are thicker than the green sheet 124 on which the internal electrode pattern 123 is formed. At this time, the green sheets 124 are laminated so that the internal electrode patterns 123A and 123B of the green sheets 124 adjacent to each other in the laminating direction are alternately shifted in the longitudinal direction of the green sheets 124. In addition, a portion in which only the internal electrode patterns 123A are laminated in the laminating direction, a portion in which the internal electrode patterns 123A and 123B are alternately laminated in the laminating direction, and a portion in which only the internal electrode patterns 123B are laminated in the laminating direction are formed.

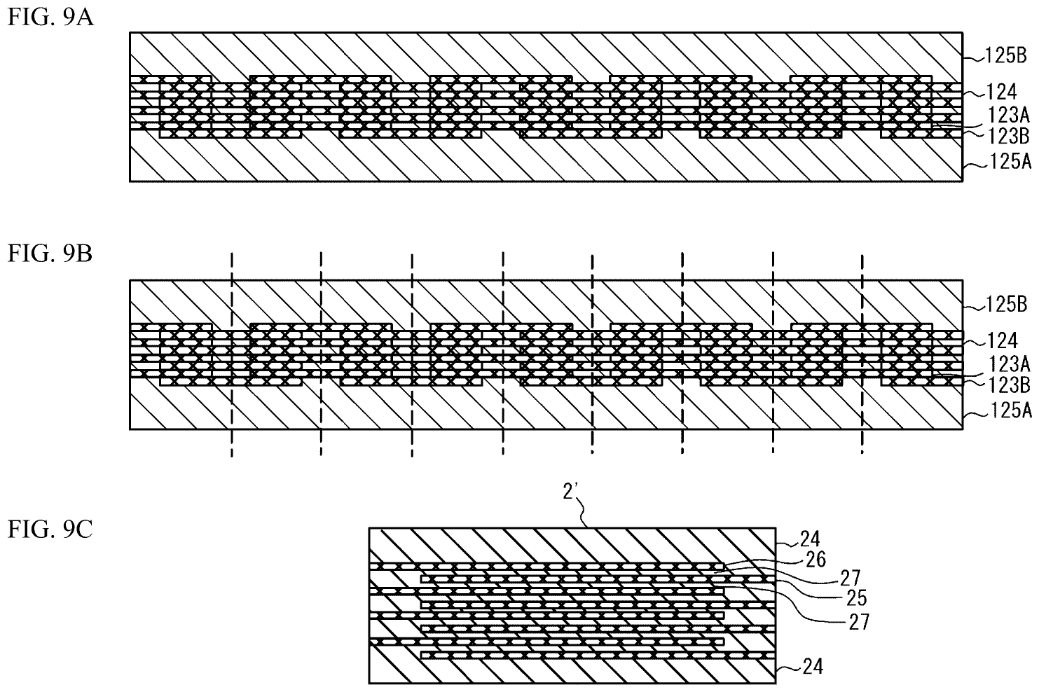

Next, as illustrated in step S5 of FIG. 7 and FIG. 9A, the multilayer block obtained in the molding process of step S4 of FIG. 7 is pressed, and the green sheets 124, 125A, and 125B are pressure-bonded. As a method of pressing the multilayer block, for example, a method of sandwiching the multilayer block between resin films and performing isostatic pressing can be used.

Next, as illustrated in step S6 of FIG. 7 and FIG. 9B, the pressed multilayer block is cut into individual rectangular parallelepiped elements. The multilayer block is cut at portions where only the internal electrode patterns 123A are laminated in the laminating direction and at portions where only the internal electrode patterns 123B are laminated in the laminating direction. For cutting the multilayer block, for example, a method such as blade dicing can be used.

At this time, as illustrated in FIG. 9C, the first internal electrode 25 and the second internal electrode 26 alternately laminated with the dielectric layer 27 interposed therebetween are formed in an individual ceramic element 2′, and the cover layers 24 are formed as each of the lowermost layer and the uppermost layer. The first internal electrode 25 is led out from the surface of the dielectric layer 27 at one of the side surfaces of the ceramic element 2′, and the second internal electrode 26 is led out from the surface of the dielectric layer 27 at the other of the side surfaces of the ceramic element 2′. In FIG. 9C, one ceramic element divided into individual pieces illustrated in FIG. 9B is illustrated in an enlarged manner in the length direction.

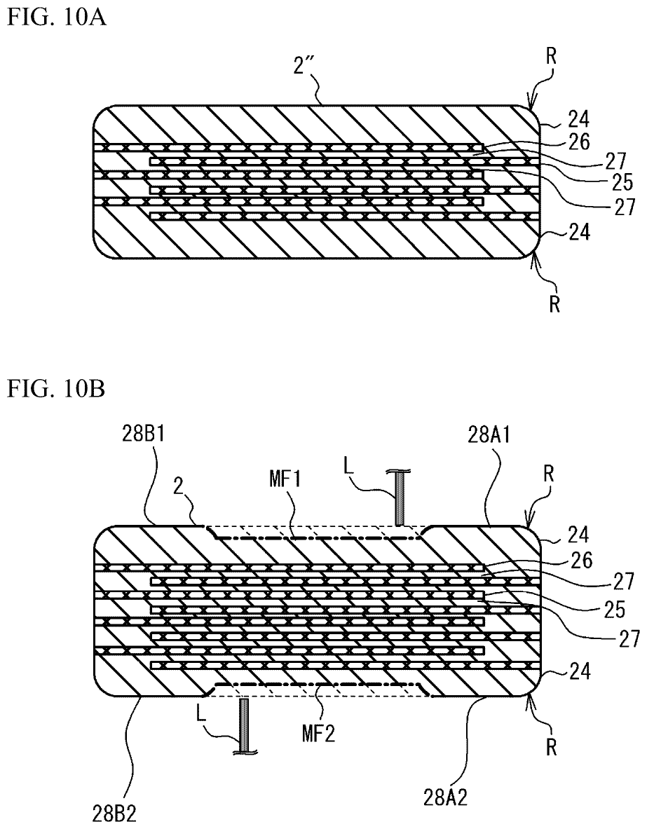

Next, as illustrated in step S7 of FIG. 7 and FIG. 10A, the ceramic element 2′ is chamfered to form a ceramic element 2″ in which the corner portions of the ceramic element 2′ are provided with curved surfaces R. The chamfering of the ceramic element 2′ may be performed by barrel polishing, for example.

Next, as illustrated in step S8 of FIG. 7, the binder contained in the ceramic element 2 chamfered in step S7 of FIG. 7 is removed. In the removal of the binder, the ceramic element 2 is heated in an N₂ atmosphere at about 350° C., for example.

Next, as illustrated in step S9 of FIG. 7 and FIG. 10B, the laser L is irradiated on predetermined surfaces of the ceramic element 2″ to form the step portions 28A1 and 28A2 and the step portions 28B1 and 28B2. To be specific, the periphery of each of the central portions of the surfaces of the ceramic element 2″ is formed into a recessed shape so as to leave the step portions 28A1 and 28A2 and the step portions 28B1 and 28B2. The intensity and irradiation range of the laser are adjusted as appropriate. Although only the step portions 28A1 and 28A2 and the step portions 28B1 and 28B2 are illustrated in FIG. 10B, the step portions 28A3 and 28A4 and the step portions 28B3 and 28B4 illustrated in FIG. 5 are formed in the same manner. That is, the laser is irradiated on the main surfaces MF1 and MF2 and the side surfaces SF1 and SF2 so that the step portions are formed at both ends of the main surfaces MF1 and MF2 and the side surfaces SF1 and SF2 in the X-axis direction.

Next, as illustrated in step S10 of FIG. 7, the conductive paste for the base layer is applied so as to cover each step portion and is dried. The conductive paste for the base layer may be applied by, for example, a dipping method. The conductive paste for the base layer contains a powder or filler of a metal used as a conductive material of the base layer 4. For example, when the metal used as the conductive material of the base layer 4 is Ni, the conductive paste for the base layer contains a powder or filler of Ni. The conductive paste for the base layer contains, as a co-fired material, for example, a ceramic component that is a main component of the dielectric layer 27. For example, particles of oxide ceramic containing barium titanate as a main component are mixed as a co-fired material into the conductive paste for the base layer. The conductive paste for the base layer contains a binder and a solvent. The base layer 4 can be formed by a conventionally known method selected as appropriate. For example, the base layer 4 may be formed by sputtering. When the base layer 4 is formed by sputtering, a resin or metal mask is used to separate the base layer 4 in the length direction (X-axis direction) of the ceramic element 2. When the base layer 4 is formed by sputtering, the co-fired material is not mixed.

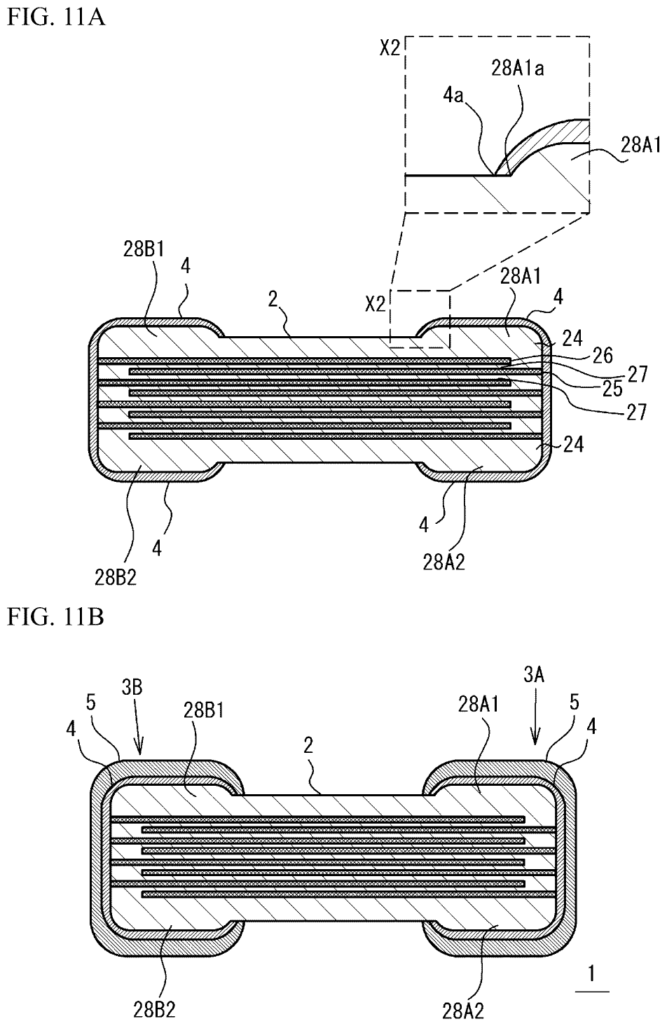

Next, as illustrated in step S11 of FIG. 7 and FIG. 11A, the ceramic element 2 to which the conductive paste for the base layer is applied in step S10 of FIG. 7 is fired, so that the first internal electrodes 25, the second internal electrodes 26 and the dielectric layers 27 are integrated with each other, and the base layer 4 integrated with the ceramic element 2 is formed. The ceramic element 2 and the conductive paste for the base layer are fired, for example, in a firing furnace at a temperature of about 1000° C. or higher and about 1400° C. or lower for about 10 minutes to about 2 hours. When a base metal such as Ni or Cu is used for that the first internal electrodes 25 and the second internal electrodes 26, the firing can be performed in the firing furnace in a reducing atmosphere in order to prevent oxidation of the first internal electrodes 25 and the second internal electrodes 26. In the formation of the base layer 4, reoxidation treatment may be performed at a temperature of 600° C. to 1000° C. in an N₂ gas atmosphere. After such firing, the base layer 4 is formed. As illustrated in FIG. 11A in which an X2 portion is enlarged, the base layer 4 is formed such that, in at least a portion of the base layer 4, the center-side end 4a of the base layer 4 is located closer to the center of the ceramic element 2 than the center-side end 28A1a of the step portion 28A1. This improves the adhesion between the base layer 4 and the ceramic element 2.

Next, as illustrated in the S12 of FIG. 7 and FIG. 11B, the plating layer 5 is formed on the base layer 7. The plating layer 5 can be formed by housing the ceramic element 2 on which the base layer 4 is formed in a barrel together with a plating solution and applying a current while rotating the barrel. When the plating layer 5 has a plurality of layers, plating is performed for each layer.

### [Effects]

In the multilayer ceramic capacitor 1 of the present embodiment, the center-side end 4a of the base layer 4 is located closer to the center of the ceramic element 2 than the center-side end of each step portion. This improves the adhesion between the ceramic element 2 and the first external electrode 3A and the second external electrode 3B, and suppresses the peeling between the ceramic element 2 and the first external electrode 3A and the second external electrode 3B.

### Second Embodiment

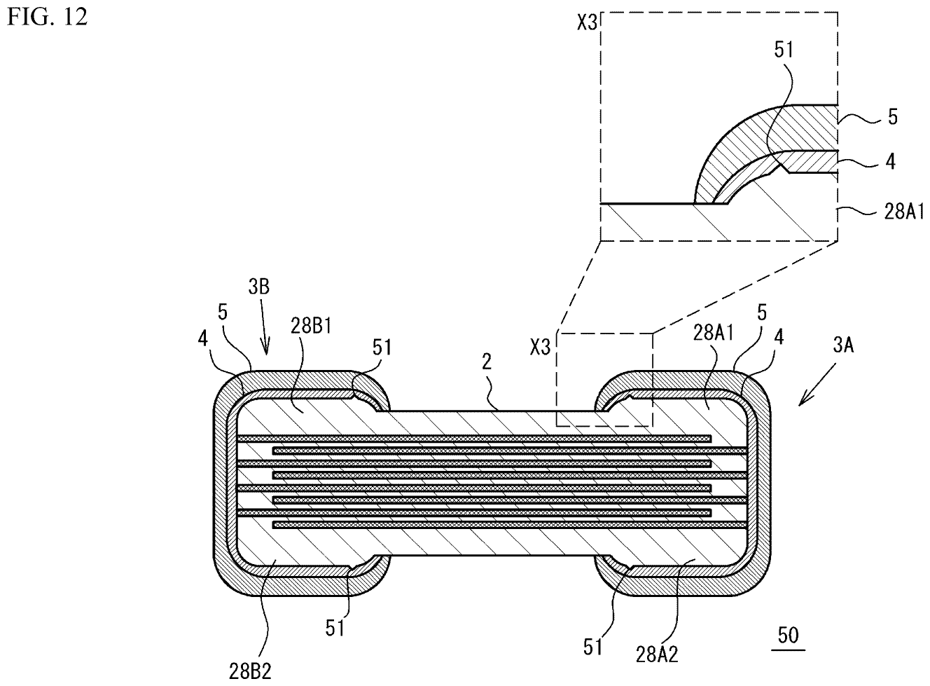

Next, a second embodiment will be described with reference to FIG. 12. FIG. 12 is a cross-sectional view of a multilayer ceramic capacitor 50 according to a second embodiment. The multilayer ceramic capacitor 50 of the second embodiment differs from the multilayer ceramic capacitor 1 of the first embodiment in that the multilayer ceramic capacitor 50 includes a protrusion 51 in each step portion. Since the other configurations are common to the first embodiment, the same reference numerals are given to the same components in the drawings, and the detailed description thereof will be omitted.

The protrusion 51 protrudes further outward from the surface of each step portion as illustrated in the enlarged view of an X3 portion. This improves the adhesion between the base layer 4 and the step portion, that is, the ceramic element 2. The number of protrusions 51 is not particularly limited, and the plurality of protrusions 51 may be provided in each step portion. The average value of the height of the protrusions can be set to 0.1 μm or more and 0.5 μm or less, preferably 0.2 μm or more and 0.4 μm or less.

### Third Embodiment

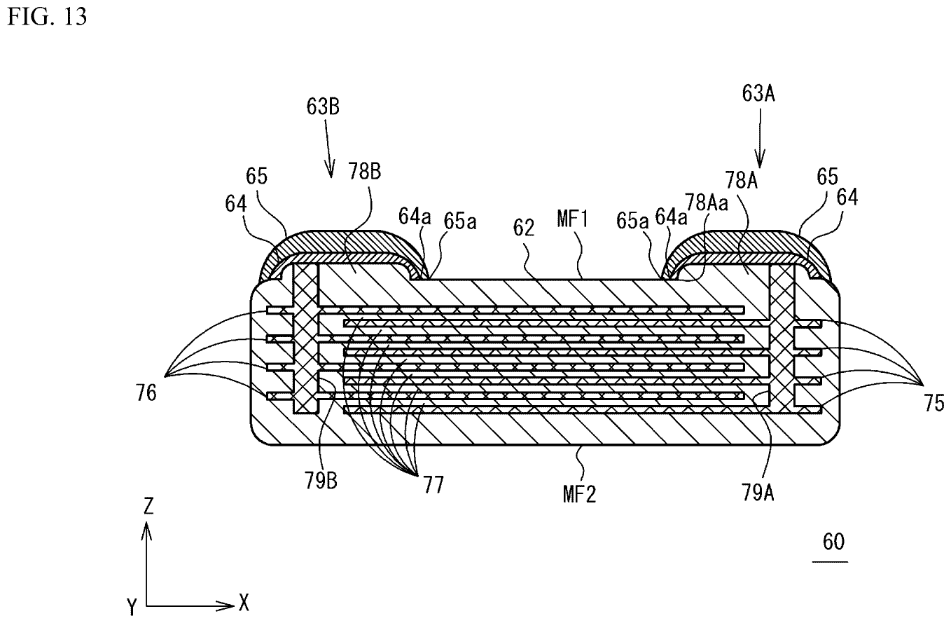

Next, a third embodiment will be described with reference to FIG. 13. FIG. 13 is a cross-sectional view of a multilayer ceramic capacitor 60 according to a third embodiment. The multilayer ceramic capacitor 60 includes a ceramic element 62 and external electrodes 63A and 63B. In the ceramic element 62, first internal electrodes 75 and second internal electrodes 76 are alternately laminated along the Z-axis direction with dielectric layers 77 interposed therebetween. The ceramic element 62 includes a pair of main surfaces MF1 and MF2 provided so as to be orthogonal to the Z-axis direction. The external electrodes 63A and 63B are provided only on the main surface MF1. This configuration is different from the configuration of the multilayer ceramic capacitor 1 of the first embodiment in which the first external electrode 3A and the second external electrode 3B are provided on one end surface and the main surfaces and the side surfaces located around the end surface.

The ceramic element 62 includes a step portion 78A and a step portion 78B at the ends of one main surface MF1 in the X-axis direction, among the pair of main surfaces MF1 and MF2. The external electrodes 63A and 63B are provided so as to cover the step portions 78A and 78B, respectively. Each of the external electrodes 63A and 63B includes a base layer 64 and a plating layer 65. When attention is focused on the portion where the step portion 78A is provided, a center-side end 64a of the base layer 64 is located closer to the center of the ceramic element 62 than a center-side end 78Aa of the step portion 78A. A center-side end 65a of the plating layer 65 is located closer to the center of the ceramic element 62 than the center-side end 64a of the base layer 64. This relationship is also the same in the portion where the step portion 78B is provided.

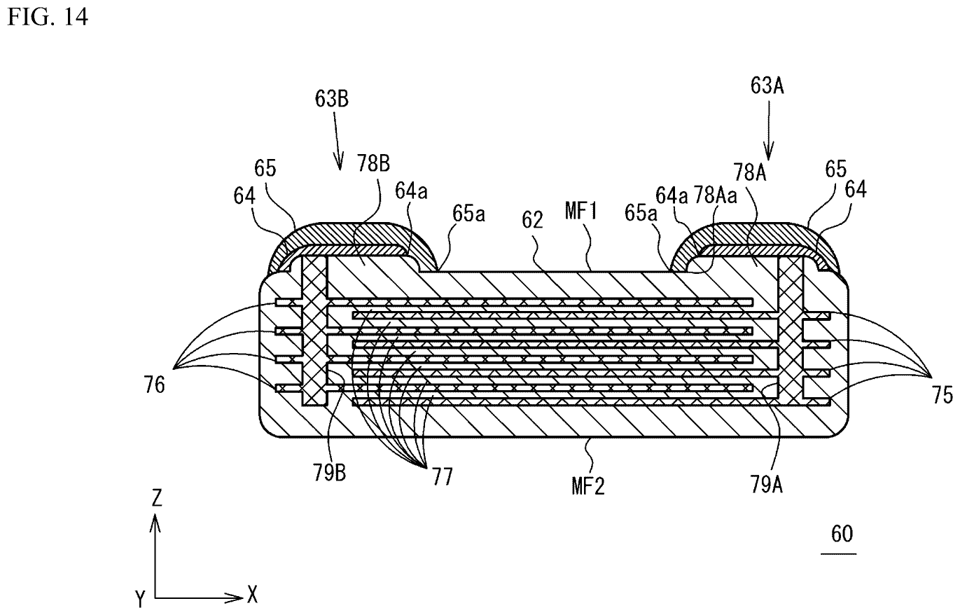

Referring to FIG. 14, the center-side end 64a of the base layer 64 is located farther from the center of the ceramic element 62 than the center-side end 78Aa of the step portion 78A.

As described above, the multilayer ceramic capacitor 60 of the present embodiment includes a portion having a cross section as illustrated in FIG. 13 and a portion having a cross section as illustrated in FIG. 14. By setting the center-side end 64a of the base layer 64 and the center-side end 78Aa of the step portion 78A to have such a relationship, it is possible to improve the adhesion between the external electrode 63A and the ceramic element 62 and to suppress the peeling between the ceramic element 62 and the external electrode 63A.

In the multilayer ceramic capacitor 60, the relationship between the center-side end 64a of the base layer 64 and the center-side end 78Aa of the step portion 78A as illustrated in FIG. 13 may be realized in a cross section at any position in the Y-axis direction. Further, the cross section in the state as illustrated in FIG. 14 does not have to be provided, and the center-side end 64a of the base layer 64 may be located closer to the center of the multilayer ceramic capacitor 60 than the center-side end 78Aa of the step portion 78A in the entire region in the Y-axis direction, as illustrated in FIG. 13. These relationships are the same in the portion where the step portion 78B is provided, and the ceramic element 62 and the external electrodes 63B can also provide the same effects as the above effects of the ceramic element 62 and the external electrodes 63A.

The first internal electrodes 75 are connected to each other through a first via 79A extending along the Z-axis direction. The first via 79A penetrates the step portion 78A and is connected to the external electrode 63A. The second internal electrodes 76 are connected to each other through a second via 79B extending along the Z-axis direction. The second via 79B penetrates the step portion 78B and is connected to the external electrode 63B.

The multilayer ceramic capacitor 60 of the third embodiment includes the external electrodes 63A and 63B only on one main surface MF1 of the pair of main surfaces MF1 and MF2. Therefore, the multilayer ceramic capacitor 60 can be thinned.

In addition, the positional relationship between the center-side end 64a of the base layer 64 and the center-side end 78Aa of the step portion 78A improves the adhesion between the external electrodes and the ceramic element 62, and thus, the peeling between the ceramic element 62 and the external electrodes can be suppressed.

In each of the above-described embodiments, the multilayer ceramic capacitor has been described as an example of a multilayer ceramic electronic component, but the present embodiment is not limited thereto. For example, the configurations of the above-described embodiments are applicable to other multilayer ceramic electronic components such as varistors and thermistors.

The above embodiments are merely examples for carrying out the present disclosure, and the present disclosure is not limited to these embodiments. It is to be understood that the various change, substitutions, and alterations could be made hereto without departing from the spirit and scope of the invention.

1. A multilayer ceramic electronic component comprising:
a ceramic element having dielectric layers and internal electrodes that are alternately laminated, a pair of main surfaces facing each other along a first axis direction, a pair of side surfaces facing each other in a second axis direction orthogonal to the first axis direction, and a pair of end surfaces facing each other in a third axis direction orthogonal to the first axis direction and the second axis direction;
step portions formed at both ends of at least one surface of the pair of main surfaces and the pair of side surfaces along the third axis direction; and
external electrodes each including a base layer provided on each of both ends of the ceramic element in the third axis direction to cover the step portions, and a plating layer covering the base layer;
wherein a center-side end of the base layer located near a center of the ceramic element is located closer to the center of the ceramic element than a center-side end of each of the step portions located near the center of the ceramic element.

2. The multilayer ceramic electronic component according to claim 1, wherein
the base layer is a conductive thin film having a thickness of 0.1 μm or more and 1.5 μm or less.

3. The multilayer ceramic electronic component according to claim 1, wherein
the step portions are provided at both ends of each of the pair of main surfaces along the third axis direction, and
each of the external electrodes includes the base layer covering each of the step portions and the plating layer covering the base layer.

4. The multilayer ceramic electronic component according to claim 1, wherein
the internal electrodes are alternately led out to the pair of end surfaces of the ceramic element, and
each of the external electrodes is continuously formed on each of the pair of end surfaces, the pair of main surfaces adjacent to the each of the pair of end surfaces, and the pair of side surfaces adjacent to the each of the pair of end surfaces.

5. The multilayer ceramic electronic component according to claim 4, wherein
the step portions are provided at both ends of each of the pair of main surfaces and the pair of side surfaces along the third axis direction, and
each of the external electrodes includes the base layer covering each of the step portions and the plating layer covering the base layer.

6. The multilayer ceramic electronic component according to claim 1, wherein
the internal electrode includes a first internal electrode and a second internal electrode laminated on the first internal electrode with the dielectric layer interposed therebetween, and
the external electrode includes a first external electrode connected to the first internal electrode, and a second external electrode provided separately from the first external electrode and connected to the second internal electrode.

7. The multilayer ceramic electronic component according to claim 6, wherein
the ceramic element includes cover layers covering the dielectric layers, the first internal electrodes and the second internal electrodes from the first axis direction, and side margins covering the dielectric layers, the first internal electrodes and the second internal electrodes from the second axis direction, and
the step portions are formed in the cover layers and the side margins.

8. The multilayer ceramic electronic component according to claim 1, wherein each of the step portion includes a protrusion.

9. The multilayer ceramic electronic component according to claim 1, wherein
the internal electrode includes first internal electrodes and second internal electrodes alternately arranged along the first axis direction,
the first internal electrodes are connected to each other through a first via extending along the first axis direction,
the second internal electrodes are connected to each other through a second via extending along the first axis direction,
the step portions are provided at both ends of one surface of the pair of main surfaces along the third axis direction,
the first via penetrates one of the step portions and is connected to one of the external electrodes, and
the second via penetrates another of the step portions and is connected to another of the external electrodes.

10. A method of manufacturing a multilayer ceramic electronic component, comprising:
forming a multilayer ceramic body having dielectric layers and internal electrodes that are alternately laminated, a pair of main surfaces facing each other along a first axis direction, a pair of side surfaces facing each other in a second axis direction orthogonal to the first axis direction, and a pair of end surfaces facing each other in a third axis direction orthogonal to the first axis direction and the second axis direction, the internal electrodes being alternately led out to the pair of end surfaces of the multilayer ceramic body;
forming step portions protruding from at least one surface of the pair of main surfaces in the first axis direction at both ends of the at least one surface of the pair of main surfaces along the third axis direction to obtain a ceramic element;
forming a base layer so that a center-side end of the base layer located near a center of the ceramic element is located closer to the center of the ceramic element than a center-side end of each of the step portions located near the center of the ceramic element; and
forming a plating layer to cover the base layer.
